(19) United States
(12) Patent Application Publication
(10) Pub. No.: US 2005/0237315 A1
(43) Pub. Date: Oct. 27, 2005

(54) Frame refresh method and circuit

(76) Inventors: Ping-Yeh Chen, Taoyuan (TW); Yung-Che Pao, Taoyuan (TW); Szu-Han Wu, Taoyuan (TW)

Correspondence Address: BIRCH STEWART KOLASCH & BIRCH, PO BOX 747, FALLS CHURCH, VA, 22040-0747, US

(21) Appl. No.: 10/949,301

(22) Filed: Sep. 27, 2004

(30) Foreign Application Priority Data
Apr. 2, 2004 (TW) 093109205

(51) Int. Cl. G09G 5/00

(52) U.S. Cl. 345/204

(57) ABSTRACT

A frame refresh method and circuit. First, a central processing unit is detected by an operating system for receiving pixel data. A power state of a video chip is then determined by the central processing unit. Finally, the pixel data is written into a random access memory or a video frame buffer according to the power state.

### BACKGROUND

The present invention relates to a frame refresh method and circuit, and more particularly to a frame refresh method for use in a handheld electronic device.

Currently, handheld electronic devices such as mobile phones use an external video chip to enhance video performance and reduce power consumption. System pixel data is saved to a random access memory (RAM) providing pixel data updates when the power of the video chip is turned off. Pixel data is copied by the central processing unit (CPU) and sent to a video frame buffer for refreshing pixel data.

FIG. 1 is a flowchart of a traditional frame refresh method for a handheld electronic device. FIG. 2 shows the internal circuit of the handheld electronic device 1, which comprises an operating system 10 (OS), a central processing unit (CPU) 11, a RAM 12 and a video frame buffer 13. The frame refresh method comprises, first, in step S1, the operating system (OS) writes pixel data to the CPU. In step S2, the CPU 11 writes the pixel data to the RAM 12. In step S3, operating system 10 sends a memory copy command to the CPU 11. In step S4, according to the received copy command, the CPU 11 copies the pixel data stored in the RAM 12. Finally, in step S5, the copied pixel data is stored in the video frame buffer 13.

The disadvantage of conventional refreshing method is the frequent updating of pixel data of the display by the operating system. The CPU must write the pixel data into RAM and copy the pixel data out of RAM to the video frame buffer for every refresh. The copy procedure consumes excessive CPU resources and power and degrades deteriorate system performance.

### SUMMARY

An embodiment of the invention provides a frame refresh method applied to a handheld electronic device. First, the operating system instructs a CPU to write a pixel data, and then check the power state of a video chip. The CPU then writes the pixel data into a RAM or a video frame buffer according to the power state.

An embodiment of the invention additionally provides a handheld electronic device, comprising an operating system, a CPU, at least an address lookup tables, a RAM, and a video frame buffer. The central processing unit is instructed by the operating system. The at least one address lookup table is searched by the central processing unit. The random access memory is coupled to the central processing unit. The video frame buffer is installed in a video chip and coupled to the central processing unit and RAM. When the operating system instructs the central processing unit to write a pixel data, the central processing unit checking a power state of a video chip, and the central processing unit write the pixel data into the RAM or a video frame buffer according to the power state.

A detailed description is given in the following with reference to the accompanying drawings.

### BRIEF DESCRIPTION OF THE DRAWINGS

Embodiments of the present invention can be more fully understood by reading the subsequent detailed description and examples with reference made to the accompanying drawings, wherein:

FIG. 1 is a flowchart showing a conventional frame refresh method of a handheld electronic device;

FIG. 2 is a block circuit diagram of a handheld device;

FIG. 3 is a schematic diagram of an embodiment of the invention;

FIG. 4 is a flowchart showing a frame refresh method of an embodiment of the invention;

FIG. 5 is a flowchart according to one embodiment of the invention;

FIG. 6 is a flowchart in according to one embodiment of the invention;

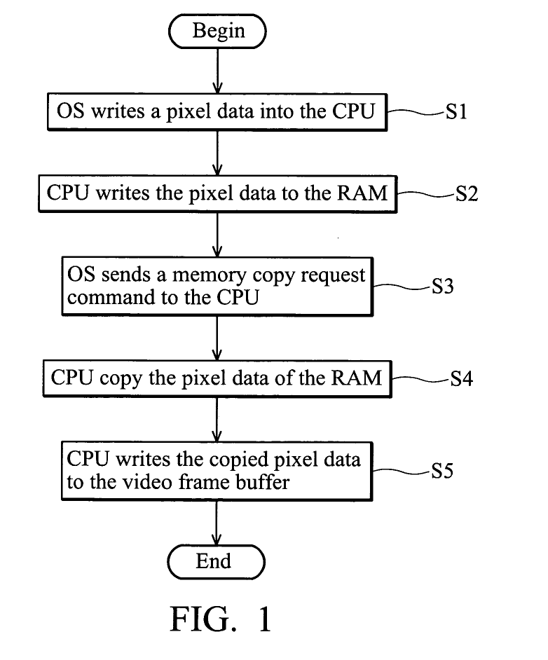

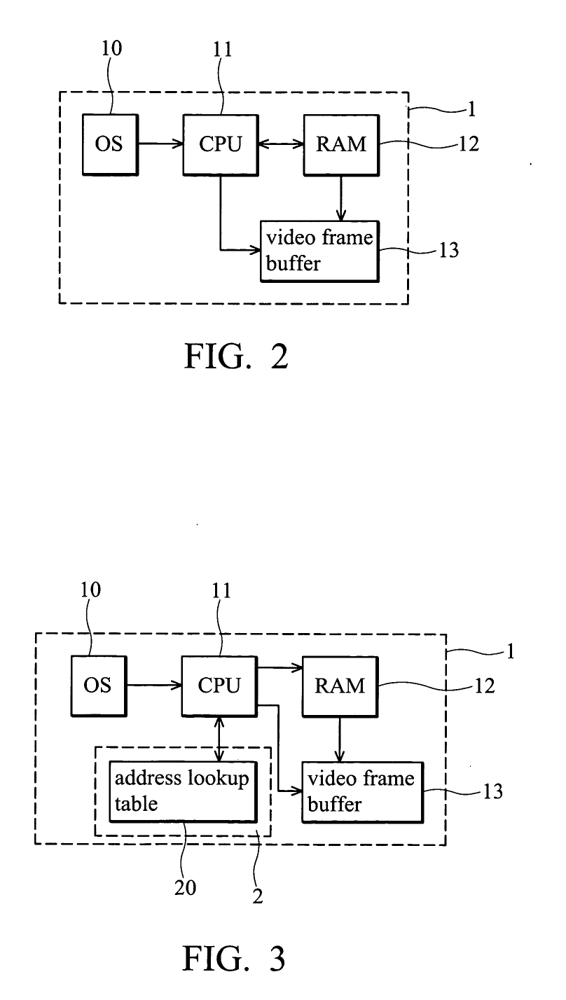

### DETAILED DESCRIPTION

FIG. 3 is a circuit block diagram of an embodiment of the invention. A handheld electronic device 1, such as a mobile phone, a personal digital assistance or a portable computer, comprises an operating system 10, a central process unit (CPU) 11, an address lookup table 20, a RAM 12, and a video frame buffer 13.

The CPU 11 is instructed by the operating system 10 to write a pixel data and a virtual address. The address lookup table 20 installed in a memory 2 stores the virtual address and a corresponding physical address, and can be read by the CPU 11 according to a power state of a video chip for searching out the corresponding physical address. The physical address may be a first physical address or a second physical address. The first physical address is inside a RAM 12. The second physical address is inside a video frame buffer 13. The RAM 12 is coupled to the CPU 11 for receiving the pixel data during an off state and receiving pixel data copied from the video frame buffer 13 when the power state of the video chip is turned from an on state to the off state. The video frame buffer 13 is coupled to the CPU 11 and the RAM 12 for receiving the pixel data during an on state and receiving pixel data copied from the RAM 12 when the power state of the video chip is turned from the off state to the on state.

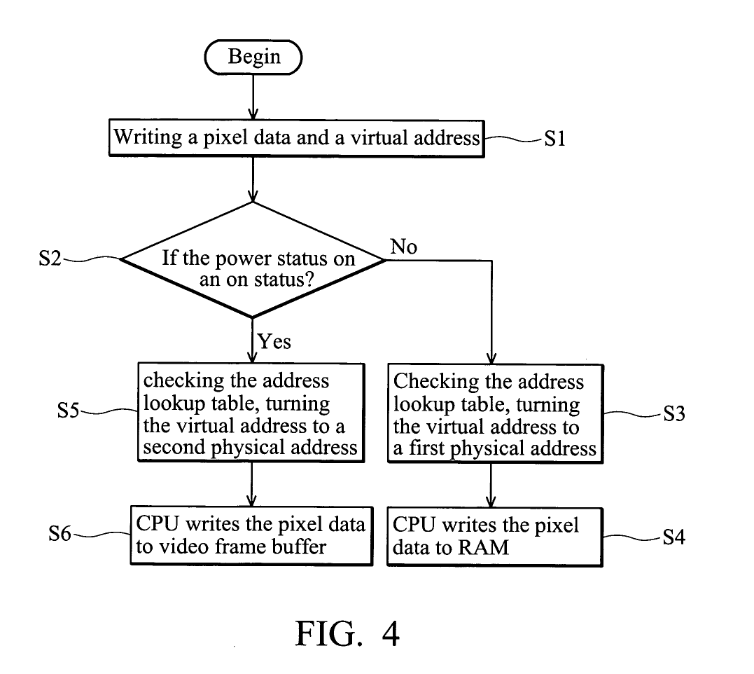

FIG. 4 illustrates a frame refresh method. First, in step S1, a pixel data and a virtual address are written into the CPU by the operating system. Next, in step S2, the power state of the video chip is determined by the CPU. If the power state is in an off state, the address lookup table is searched by the CPU for transforming the virtual address to a corresponding first physical address in step S3, wherein the first physical address is inside the RAM. In step S4, the pixel data is written to the first physical address of the RAM by the CPU.

If the power state of the video chip is in an on state, the address lookup table is searched by the CPU for transforming the virtual address to a corresponding second physical address in step S5. The second physical address is inside the video frame buffer. In step S6, the pixel data is written to the second physical address of the video frame buffer by the CPU.

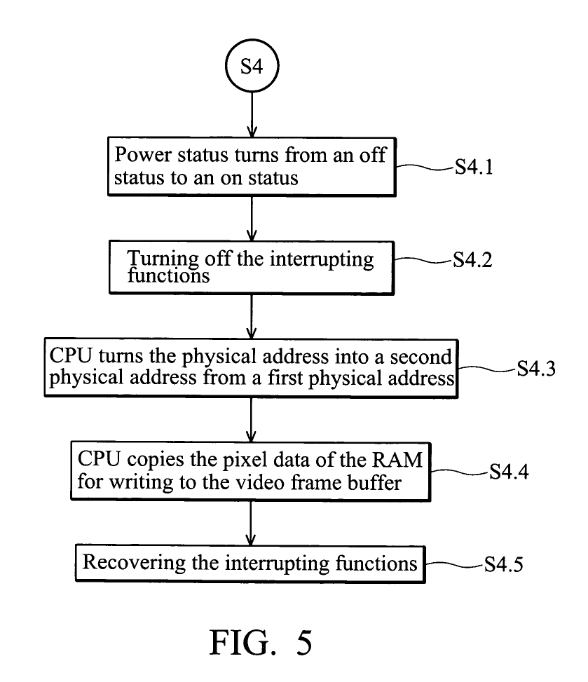

FIG. 5 is a flowchart when the power of the video chip is turned from an off state to an on state. In step 4.1, when the CPU detects that the power state of the video chip is turned from an off state to an on state. The video chip is turned on and the interrupt functions are then turned off for avoiding other interruptions. Next, the content of the address lookup table is changed by the CPU in step 4.3. The first physical address which corresponds to the virtual address is changed to the second physical address. In step 4.4, the pixel data stored in the RAM is copied by the CPU and written to the video frame buffer. Finally, in step 4.5, the interrupt functions are recovered by the CPU.

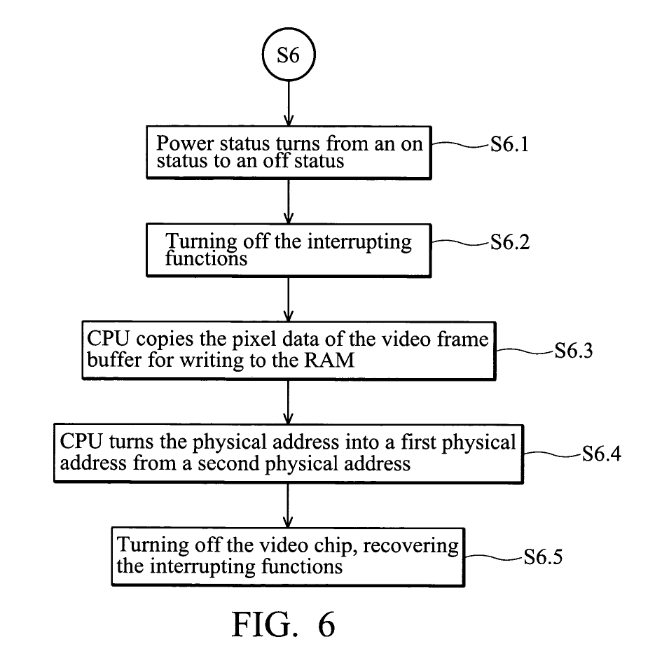

FIG. 6 is a flowchart showing when the power state of the video chip turned from an on state to an off state. In step 6.1, when CPU detects that the power of the video chip is turned from an on state to an off state. In step 6.2, the interrupt functions are turned off by the CPU to prevent other interruptions. In step 6.3, the pixel data stored in the video frame buffer is copied and written to the RAM. In step 6.4, the content of the address lookup table is changed by the CPU. The second physical address corresponding to the virtual address is changed to the first physical address. Finally, in step 4.5, the video chip is turned off and the interrupt functions are recovered by the CPU.

The frame refresh method and circuit of an embodiment of the invention eliminates the need to coping pixel data each time. Additionally, the video chip is turned off when the power of the video chip is in an off state, thus saving more power. Further, the content of the address lookup table can be changed according to the power state. When the power state is in an off state, the pixel data is written to the RAM directly. When the power state is in an on state, the pixel data is written to the video frame buffer directly, thus increasing the frame refresh performance.

While the invention has been described by way of example and in terms of the preferred embodiment, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation to encompass all such modifications and similar arrangements.

1. A frame refresh method, which is adapted to a handheld electronic device, comprising the following steps:
a. an operating system instructing a central processing unit to write a pixel data;
b. the central processing unit determining a power state of a video chip; and
c. the central processing unit writing the pixel data into either a random access memory or a video frame buffer according to the power state.

2. The frame refresh method as claimed in claim 1, wherein the operating system provides a virtual address corresponding to the pixel data, the virtual address corresponds to a first physical address or a second physical address, the first physical address is inside the random access memory, and the second physical address is inside the video frame buffer.

3. The frame refresh method as claimed in claim 2, when the power state is in an off state, the virtual address corresponds to the first physical address, and the central processing unit writes the pixel data to the random access memory.

4. The frame refresh method as claimed in claim 2, when the power state is in an on state, the virtual address corresponds to the first physical address, and the central processing unit writes the pixel data to the video frame buffer.

5. The frame refresh method as claimed in claim 3, when the power state of the video chip is turned from an off state to an on state, further comprising the following steps:
changing the first physical address corresponding to the virtual address to a second physical address; and
copying the pixel data in the random access memory to the video frame buffer.

6. The frame refresh method as claimed in claim 4, when the power state of the video chip is turned from an on state to an off state, further comprising the following steps:
copying pixel data of the video frame buffer to the random access memory; and
changing the second physical address corresponding to the virtual address to a first physical address.

7. A hand held electronic device, comprising:
an operating system;
a central processing unit, instructed by the operating system;
at least one address lookup table, searched by the central processing unit;
a random access memory, coupled to the central processing unit; and
a video frame buffer, installed in a video chip and coupled to the central processing unit and random access memory;
when the operating system instructs the central processing unit to write a pixel data, the central processing unit checking a power state of a video chip, and the
central processing unit write the pixel data into the random access memory or a video frame buffer according to the power state.

8. The handheld device as claimed in claim 7, wherein the operating system providing a virtual address corresponding to the pixel data, the virtual address corresponding to a first physical address or a second physical address, the first physical address is inside the random access memory, and the second physical address is inside the video frame buffer.

9. The handheld device as claimed in claim 7, when the power state is in an off state, the content in the address look up table is the virtual address corresponding to the first physical address.

10. The handheld device as claimed in claim 8, when the power state is in an on state, the content in the address look up table is the virtual address corresponding to the second physical address.

11. The handheld device as claimed in claim 8, when the power state of the video chip is turned from an off state to an on state, the content in the address look up table changing the first physical address corresponding to the virtual address to a second physical address, and then copying pixel data of the random access memory to the video frame buffer.

12. The handheld device as claimed in claim 8, when the power state of the video chip is turned from an on state to an off state, copying pixel data of the video frame buffer to the random access memory; and then changing the second physical address corresponding to the virtual address to a first physical address.

13. The handheld device as claimed in claim 7, wherein the handheld device is a cell phone, a personal digital assistance or a portable computer.
